(19) United States
(12) Patent Application Publication
(10) Pub. No.: US 2001/0013037 A1
(43) Pub. Date: Aug. 9, 2001

(54) Information communication system, information communication method, and information provision business method

(75) Inventor: Hidehiro Matsumoto, Tokyo (JP)

Correspondence Address: FOLEY & LARDNER, Washington Harbour, 3000 K Street, N.W., Suite 500, P.O. Box 25696, Washington, DC, 20007-8696, US

(73) Assignee: NEC CORPORATION

(21) Appl. No.: 09/777,902

(22) Filed: Feb. 7, 2001

(30) Foreign Application Priority Data
Feb. 9, 2000 (JP) 2000-031346

(51) Int. Cl. G06F 17/30; G06F 17/60

(52) U.S. Cl. 707/5; 707/10; 705/26

(57) ABSTRACT

An information communication system is disclosed, in which a service information provider registers in advance service information in information provision means which is managed by a carrier to provide the service information, and a user receives the service information by accessing the information provision means via a communication network. This system includes a database for separately storing profile information indicating attribute information of the user and preference information indicating the preference and taste of the user upon encrypting the profile information and preference information. An information communication method and information communication business method are also disclosed.

### BACKGROUND OF THE INVENTION

1. Field of the Invention

The present invention relates to an information communication system, information communication method, and information provision business method and, more particularly, to an information communication scheme in which a service information provider registers, in advance, service information in an information provision means such as a portal site serving as a service information communication window managed by a carrier, and a user receives the service information by accessing the information provision means via a communication network.

2. Description of the Prior Art

The Internet can directly provide users with advertisements and information. Increasing numbers of service information providers such as advertising agencies and value-added carriers use the Internet as a medium for advertisements and information. At the same time, radio portable information terminals serving as mobile communication terminals capable of connecting to the Internet by using radio communication paths have been widely used. The user of each portable information terminal wants to acquire information necessary for himself/herself quickly. In addition, service information providers such as advertising agencies and value-added carriers are required to effectively advertise merchandise and services requested by the sponsors with respect to targeted users.

More specifically, a user can receive advertisement information about merchandise and services as service information by accessing a mobile portal site, which is managed by a carrier to provide service information, via the Internet. FIG. 7 schematically shows the relationship between a mobile portal and companies and a radio portable terminal (user) which use the portal. In this case, the “portal” indicates an Internet WWW (World Wide Web to be referred to as a Web) site which provides attractive contents and various services so as to let the largest possible number of users access it.

Referring to FIG. 1, a user 1 accesses a portal site 41 of a mobile portal 4 by using a radio portable terminal. This mobile portal 4 is managed (provision of environments and management of the portal site) by a carrier 2 (108). In the portal site 41, various information about merchandise and services (provision of service information such as advertisements and development of services) is registered (110, 111) by an advertising agency 3a and user/third party manufacturer 3b (to be generically termed as service information providers). The user 1 can receive desired service information (receive services) by accessing the portal site 41 (102). Note that the user/third party manufacturer 3b can also request the advertising agency 3a to advertise merchandise and services (112).

Conventionally, to obtain information such as history records indicating which kinds of users have accessed service information provided by the service information provider such as the advertising agency 3a or user/third party manufacturer 3b, the provider, for example, counts a browse count (access count) or uses questionnaires.

In the above conventional information communication system, since the radio portable terminal of the user is a mobile unit, the speech communication position of the user and type of terminal are captured by the carrier via the communication system, and individual attribute information and the like at the time the user makes a contract is also captured. In addition, when the user accesses the portable site, preference and taste information of the user can be captured. In spite of this fact, in the conventional information communication system shown in FIG. 1, a service information provider such as the advertising agency 3a or user/third party manufacturer 3b obtains history records indicating what kinds of users have accessed and used the service information by using a primitive method, e.g., a method of simply checking a browsing count or a method using questionnaires.

Note that techniques of acquiring user information have been proposed in Japanese Unexamined Patent Publication Nos. 10-21302 and 10-326289. Both the techniques are schemes of acquiring only individual attribute information of users (to be referred to as profile information), i.e., information about sexes, ages, annual incomes, educational background, and the like, but the above references do not refer to acquisition of preference and taste information of users (to be referred to as preference information). With these disclosed techniques, a service information provider such as an advertising agency or user/third party manufacturer cannot effectively acquire information indicating how provided service information is used by users.

In addition, when such profile information and preference information are to be acquired, it is very important to maintain privacy of information. It is therefore important to consider concealment of information.

### SUMMARY OF THE INVENTION

The present invention has been made to solve the above problems in the prior art, and has as its object to provide an information communication system, information communication method, and information provision business which effectively acquire preference attribute information of users as well as profile information of the users with concealment of information, and allow service information providers to effectively use these pieces of information.

In order to achieve the above object, according to the first main aspect of the present invention, there is provided an information communication system in which a service information provider registers in advance service information in information provision means, managed by a carrier, for providing the service information, and a user receives the service information by accessing the information provision means via a communication network, comprising a database for separately storing profile information indicating attribute information of the user and preference information indicating a preference and taste of the user upon encrypting the profile information and preference information.

The profile information and preference information in the first aspect are pieces of information for which the user gave consent to disclosure. Means for generating a keyword for searching/extracting information stored in the database is provided on the service information provider side.

This system includes information search means for searching the database to extract information in accordance with the keyword and supplying the extracted information to the service information provider. The information search means also supplies key information required to decrypt the extracted information. The system includes storage means for, when the user accesses the information provision means, obtaining the profile information and preference information in accordance with contents of the access to the information provision means, and storing the profile information and preference information in the database.

The storage means acquires and stores terminal attribute information of the user and communication attribute information required to access the information provision means as the profile information. The storage means also acquires and stores preference information on the basis of link information obtained when the user sequentially selects menu items on a display screen in accessing the information provision means. In addition, the storage means acquires and stores a filter condition as the preference information which is set when the user receives information from the information provision means and indicates necessity/nonnecessity of information. The storage means also acquires and stores positional information and a type of communication line, as the preference information, when the user is accessing. Furthermore, the storage means acquires and stores as the preference information a use frequency of an access device through which the user is accessing.

In order to achieve the above object, according to the second main aspect of the present invention, there is provided an information communication method in which a service information provider registers in advance service information in information provision means, managed by a carrier, for providing the service information, and a user receives the service information by accessing the information provision means via a communication network, comprising the step of separately storing profile information indicating attribute information of the user and preference information indicating a preference and taste of the user in a database upon encrypting the profile information and preference information.

The profile information and preference information in the second aspect are pieces of information for which the user gave consent to disclosure. This method can further include the step of generating a keyword for searching/extracting information stored in the database on the service information provider side in the second aspect.

This method further includes the information search step of searching the database to extract information in accordance with the keyword and supplying the extracted information to the service information provider. The information search step comprises also supplying key information required to decrypt the extracted information. The method may also include the storage step of, when the user accesses the information provision means, obtaining the profile information and preference information in accordance with contents of the access to the information provision means, and storing the profile information and preference information in the database.

The storage step comprises acquiring and storing terminal attribute information of the user and communication attribute information required to access the information provision means as the profile information. The storage step comprises acquiring and storing the preference information on the basis of link information obtained when the user sequentially selects menu items on a display screen in accessing the information provision means. The storage step comprises acquiring and storing a filter condition as the preference information which is set when the user receives information from the information provision means and indicates necessity/nonnecessity of information. The storage step comprises acquiring and storing positional information and a type of communication line, as the preference information, when the user is accessing. In addition, the storage step comprises acquiring and storing as the preference information a use frequency of an access device through which the user is accessing.

In order to achieve the above object, according to the third main aspect of the present invention, there is provided, in an information communication system in which a service information provider registers in advance service information in information provision means, managed by a carrier, for providing the service information, and a user receives the service information by accessing the information provision means via a communication network, an information communication business method which uses a database in which profile information indicating attribute information of the user and preference information indicating a preference and taste of the user are stored after the profile information and preference information are encrypted and provides the stored information to the service information provider with a charge, comprising the steps of generating a keyword which is used by the service information provider to search the database, and searching the database in accordance with the keyword, extracting information, and providing the extracted information to the service information provider.

The profile information and preference information in the third aspect are pieces of information for which the user gave consent to disclosure. In addition, key information for decrypting the extracted information is also provided when the extracted information is provided to the service information provider.

The function of the present invention will be described below. In a communication system for communicating information to individuals, profile information which is the attribute information of the terminal used by each individual and preference information which is the preference and taste information of each individual are separately encrypted, and these pieces of encrypted information are to be used upon deletion of information (map information) which can specify both profile information and preference information with the same item (key).

This prevents profile information and preference information as individual information from being linked to each other, thus preventing leakage of specific individual information. In addition, communication resources and information resources can be effectively used by providing only necessary information to the user of each terminal on the basis of profile information and preference information. A service information provider such as a value-added carrier or advertising agency who uses a communication infrastructure such as the Internet as an advertisement or information medium can purchase part of preference information and profile information from a radio carrier with keywords and immediately reflect it in the effects of advertisements. Furthermore, each user can prevent leakage of information by giving or rejecting consent to disclosure of individual information independently of a connection contract.

As is obvious from the above aspects, according to the present invention, when a user accesses a portal site and selects various menu items on the display screen to receive service information, the profile information and preference information of the user are acquired. These pieces of information are then encrypted and stored in a database. An advertising agency can properly grasp the use state of an advertisement to an indefinite number of users by searching/extracting information from the database with keywords. This makes it possible to effectively provide advertisements and service information. This also allows secondary use of information resources.

In each aspect described above, a carrier manages both a profile database and a preference database. However, the same effects as described above can also be obtained even if a carrier manages a profile database, and a value-added carrier manages a preference database. In each aspect described above, the Web is mainly referred to. However, the present invention can also be applied to a service using a messaging server such as a news distribution service (VMS) using electronic mail.

The above and many other objects, features and advantages of the present invention will become manifest to those skilled in the art upon making reference to the following detailed description and accompanying drawings in which preferred embodiments incorporating the principle of the present invention are shown by way of illustrative examples.

### BRIEF DESCRIPTION OF THE DRAWINGS

FIG. 1 is a block diagram showing the schematic overall arrangement of a conventional information communication system applied to a mobile portal;

FIG. 2 is a block diagram showing the schematic overall arrangement of an information communication system according to an embodiment of the present invention;

FIG. 3 is a block diagram showing the schematic overall arrangement of an information communication system according to the present invention which is applied to a mobile portal;

FIG. 4 is a flow chart showing the operation of the embodiment of the present invention;

FIG. 5 is a block diagram showing the schematic overall arrangement of an information communication system according to another embodiment of the present invention;

FIG. 6 is a flow chart showing operation to be performed when the profile information and preference information of a user are acquired in the information communication system according to the present invention; and

FIG. 7 is a view showing the relationship between windows on a portable terminal and a profile database and preference database in the information communication system according to the present invention.

### DETAILED DESCRIPTION OF PREFERRED EMBODIMENTS

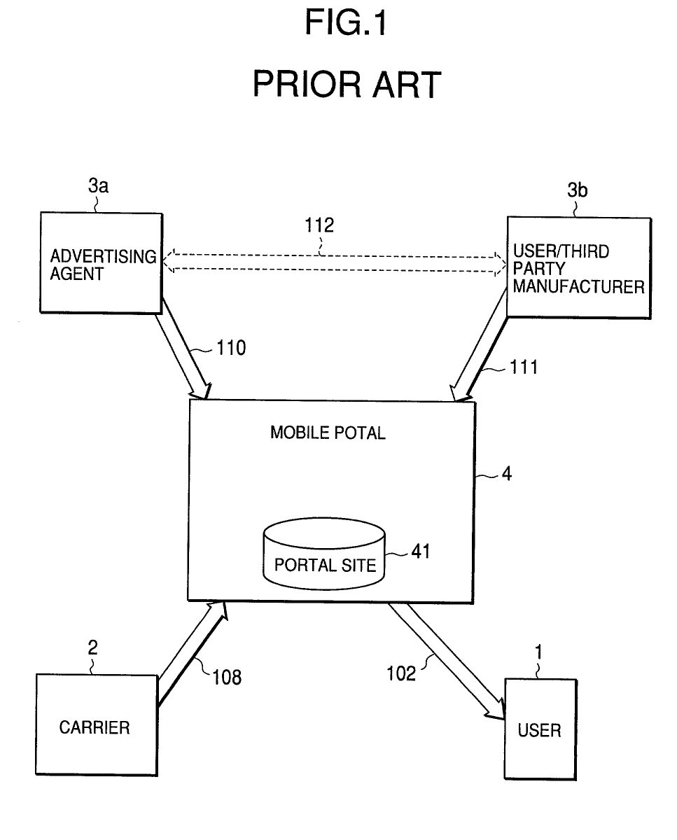

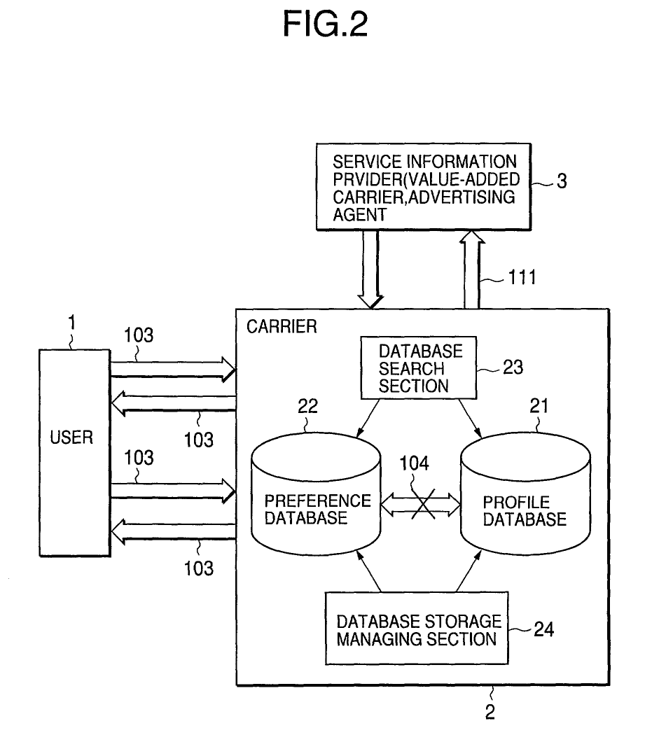

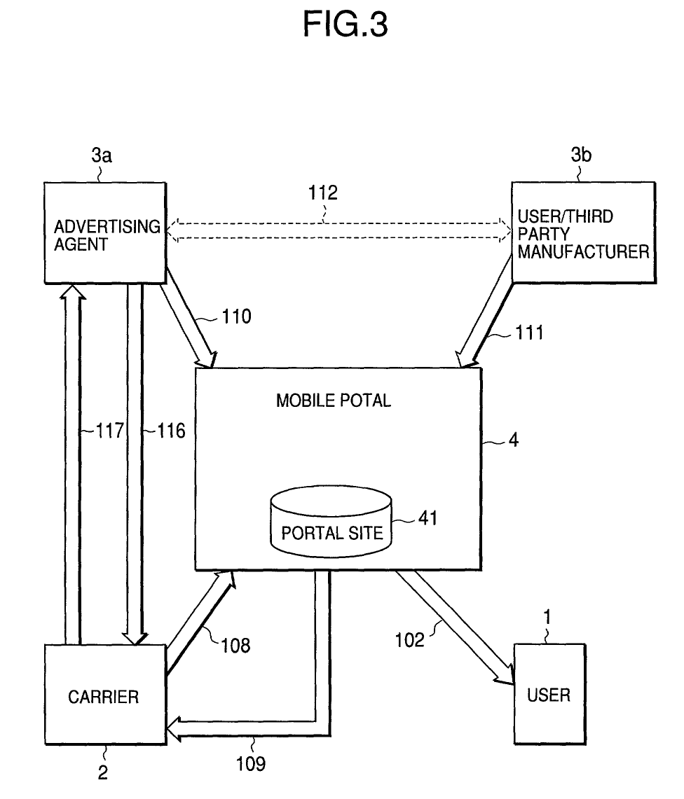

Several preferred embodiments of the present invention will be described below with reference to the accompanying drawings. FIG. 2 is a block diagram showing the schematic overall arrangement of an information communication system according to the present invention. The same reference numerals as in FIG. 1 denote the same parts in FIG. 2. Referring to FIG. 2, the information communication system according to the present invention is comprised of a user 1 who operates a radio portable terminal, a carrier 2, and a service information provider 3 which registers various service information, in advance, in a portal site (see FIG. 3) serving as a service information provision window managed by the carrier 2 to provide the information to the user 1.

The user 1 makes a connection contract with the carrier 2 to use a radio portable terminal (101) and receives services such as data communication, information distribution, and voice communication by paying a communication charge and service charge to the carrier (102). In this case, the carrier 2 acquires the positional information of the radio portable terminal, charging information, the type of terminal, and the like as profile information from the radio communication system through a database storage managing section 24, and stores the information in a profile database 21.

Note that in this case, consent to the disclosure of profile information or preference information (to be described later) is checked in advance in making connection contract with each user (103), and only the information of the user who gave his/her consent to the disclosure is stored in the database.

The carrier 2 can know which service information the user 1 having a radio portable terminal has selected from various service information by operating on the screen of the portable terminal. The carrier 2 therefore acquires preference information indicating, for example, user's preferences and tastes in accordance with this screen operation, and causes the database storage managing section 24 to store the information in a preference database 22.

In this case as well, only the information about the user who has gave his/her consent to the disclosure of reference information is stored in the database. Note that in order to conceal such individual information, processing such as encryption or deletion is performed to inhibit the generation of map information (a telephone number, detailed address, individual identification number, and the like) for the correspondence between preference information and profile information (104). An incentive such as a reward or gift is given to a user who has given his/her consent to the disclosure of profile information or preference information, when such information is actually disclosed (105).

The service information provider 3 uses a communication infrastructure such as the Internet as a medium for advertisements and information, and includes value-added carriers, advertising agencies, and the like. The service information provider 3 registers service information, e.g., various advertisements, in a portal site managed by the carrier 2 in advance to allow the user 1 to receive desired service information by accessing the portal site via a communication network such as the Internet.

To acquire profile information or preference information, the service information provider 3 sends a keyword corresponding to the contents of information to be provided and an information provision charge to the carrier 2 (106). The service information provider 3 then receives the profile information or preference information, which is searched out in accordance with the keyword and processed, from the carrier 2 (107).

When a database search section 23 receives the keyword sent from the service information provider 3, the carrier 2 searches the databases 21 and 22 in accordance with the keyword, processes the extracted information by, e.g., adding a check period to the information, and returns it to the service information provider 3.

FIG. 3 is a block diagram showing the schematic overall arrangement of an information communication system of the present invention which is applied to a mobile portal in comparison with the prior art shown in FIG. 1. The same reference numerals as in FIG. 3 denote the same parts in FIGS. 1 and 2. Referring to FIG. 3, a mobile portal 4 serves as an information provision window dedicated to mobile communication. This system differs from the system in FIG. 1 in that transmission of a keyword (106) and corresponding provision of value-added information (107) are added between the advertising agency 3a and the carrier 2 as shown in FIG. 2, and the carrier 2 reads out profile or preference information from the mobile portal 4 (109).

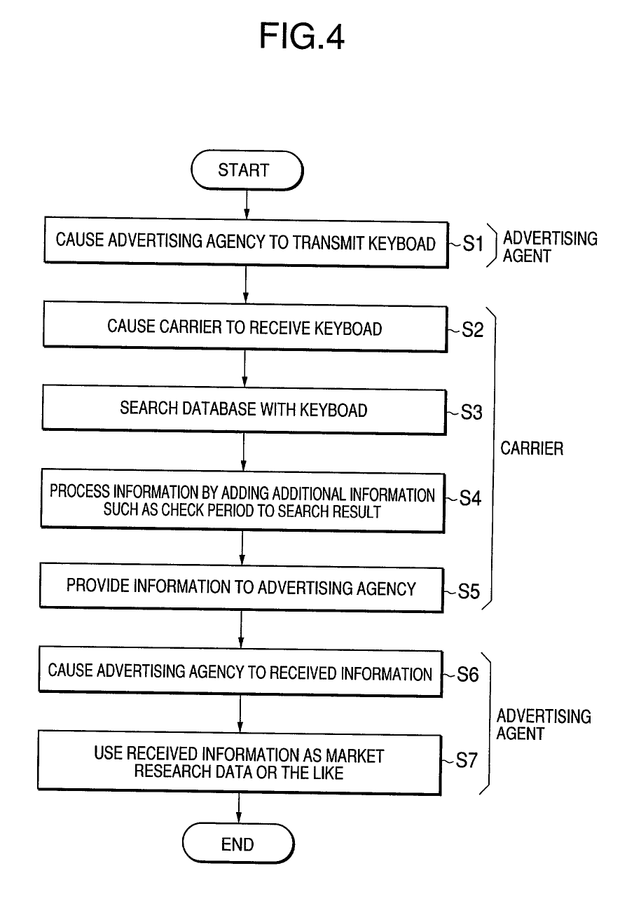

The operation of this embodiment of the present invention will be described with reference to the flow chart of FIG. 4. Assume that an advertising agency which uses a communication infrastructure such as the Internet as a medium for advertisements and information uses the embodiment of the present invention to check an advertising effect on an advertised article.

The advertising agency sends, to the carrier, an article name, and age bracket, sex, associated articles, fields of interest, and the like of buyers as keywords (step S1). The database search section 23 of the carrier extracts profile information or preference information about each user who has made a connection contract and has given his/her consent to disclosure from the database 21 or 22 (step S3), processes the extracted information by adding additional information thereto (step S4), and returns the resultant information to the advertising agency (step S5).

Such information is encrypted for concealment, and hence decryption key information for decrypting the information is also provided to the advertising agency at the same time. The advertising agency receives this information (step S6), decrypts it, and can effectively use it as market research data or the like (step S7).

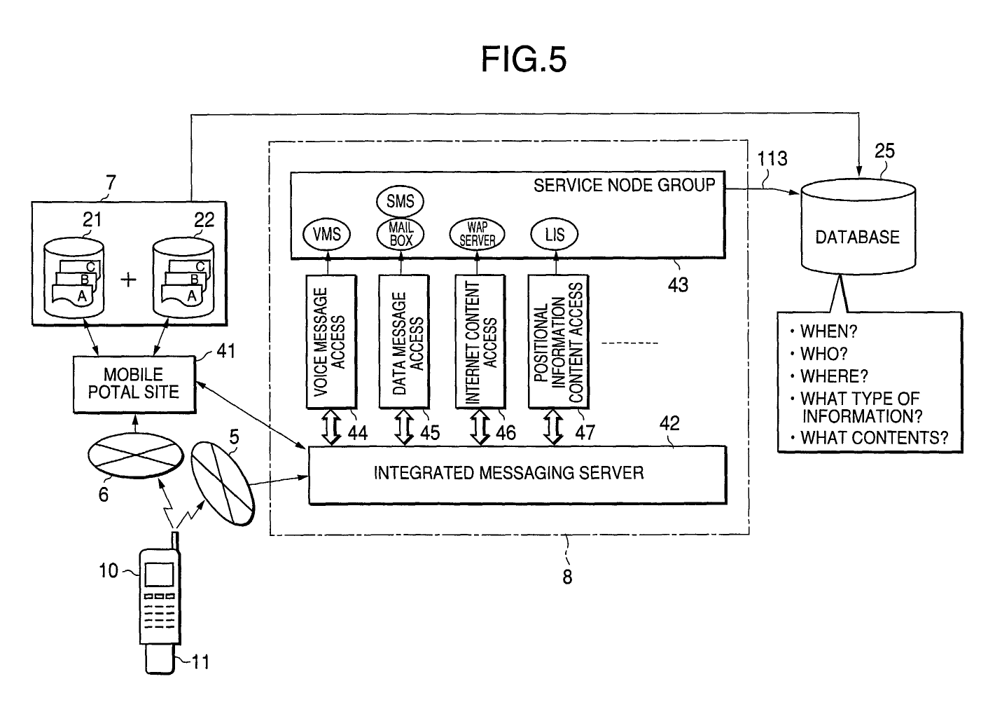

FIG. 5 shows the schematic overall arrangement of an embodiment different from the embodiment of the present invention which is shown in FIGS. 2 and 3. In this embodiment, a carrier manages an information provision server section 8 as well as a mobile portal 41 as information provision means. Pieces of user access information indicating how users have used an integrated messaging server 42 and a service node group 43 serving as access nodes for handling various access nodes (voice message access 44, data message access 45, Internet content access 46, positional information content access 47, and the like), which constitute the information provision server section 8, are concentrated and stored in a new database 25, together with pieces of subscriber management information 7 obtained as profile information and preference information from the mobile portal 41.

Referring to FIG. 5, reference numerals 5 and 6 denote radio networks; 10, the radio portable terminal of a user; and 11, an SIM (Smart Information Manager) card storing individual information.

Referring to FIG. 5, reference symbol VMS denotes a value-added message service which is a news distribution service using electronic mail; SMS, a short mail (short message) service; WAP, a wireless application protocol; and LIS, a location information service.

Assume that an advertising agency sets new music release information as voice messages and Internet contents in the mobile portal 4 in advance. In this case, a user sees the advertisement for this new music release information at the mobile portal 4, and can listen to the corresponding released music or receive nearby store information on the basis of the positional information of the radio portable terminal 10. Since preference information is stored in the new database 25 every time a user accesses the portal, the carrier can add additional information such as a check period to the stored information and sell/provide the resultant information to the advertising agency.

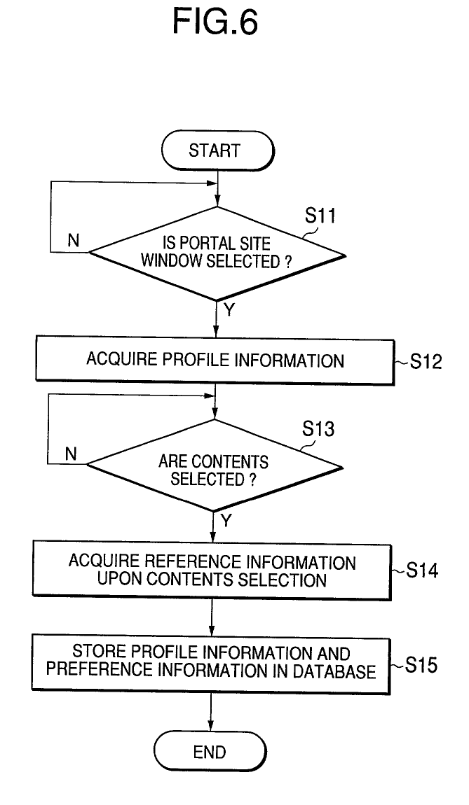

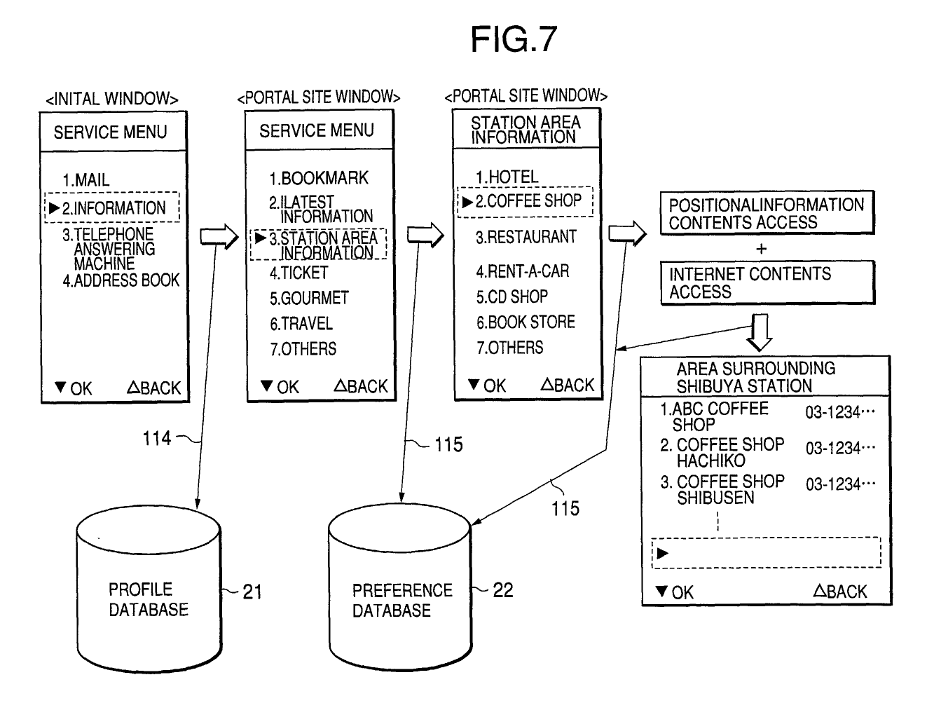

FIGS. 6 and 7 show operation to be performed when a user acquires profile information and preference information by operating on the screen of a radio portable terminal. FIG. 6 is a flow chart for the operation. FIG. 7 is a view showing the correspondence between windows on the portable terminal and the profile database 21 and preference database 22.

If the user selects “2. Information” from the selection menu on the initial window shown in FIG. 7 to access the portal site (step S11 in FIG. 6), profile information such as a terminal type and position information is acquired (114 in FIG. 7; step S12 in FIG. 6). A portal site window is set on the display screen of the portable terminal in response to the above selection. If the user selects, for example, the contents of “3. Station Area Information” (step S13 in FIG. 6), preference information is acquired upon this contents selection (115 in FIG. 7; step S14 in FIG. 6).

If the user selects “2. Coffee Shop” of “Station Area Information” to acquire next detailed information, preference information is acquired upon this contents selection. Subsequently, every time the user selects “Positional Information Contents” and “Internet Access Contents”, preference information corresponding to such contents selection is acquired.

These acquired profile information and preference information are separated and encrypted to be stored in the databases 21 and 22, respectively (step S15). Obviously, as described above, such information is stored in the databases only when users have given their consent to the disclosure of information. In general, a user gives his/her consent to the disclosure of profile information, preference information, and the like when he/she makes a connection contract with a carrier. Alternatively, a selection item for consent to the disclosure of information may be set on the window displayed when a user accesses a mobile portal site through a potable terminal so as to allow the user to select it.

Modes of acquiring profile information and preference information will be described in detail below. A mode of acquiring profile information will be described first. At the time of connection to a portal, a port number, IP (Internet Protocol) address, MAC (Media Access Control) address, access telephone number, access device type, and the like can be acquired in extended definitions in HTTP (Hyper Text Transfer Protocol) which is a protocol used on the Web. Assume that a given user wants to receive an information service through the Web, and a portable telephone and personal computer (PC) can connect as clients to the Internet. In this case, when the user uses the portable telephone or PC capable of connection to the Internet, he/she must set at least terminal attributes such as the size of a display area, the number of colors, and the capability of displaying images and communication attributes such as a port number for access to a Web site as an information source, IP address, MAC address, and access number. These attributes are profile information.

The user receives information from the Web site as the same information source through the portable telephone or PC capable of connection to the Internet in accordance with a purpose or application. In this case, if the Web site as the information source grasps what types of terminals/clients are currently accessing, the availability of a communication path can be improved by sending only required data. In addition, information can be effectively provided by changing the contents of information to be provided in accordance with the number of clients connected to the Web site. In general, such profile information is sent by a server as an information source or a gateway server according to the HTTP extended procedure but is not currently used as standard information about map information linking an individual who is accessing and a device.

A mode of acquiring preference information will be described next. This is a method of acquiring keywords by tracing and analyzing a link state (e.g., URL: Uniform Resource Locator) of Web sites which a user has accessed. When a client receives information, some information sources have means (called links) for moving to different information sources. Tracing these links will reflect the preferences of a client user and the importance of information. Therefore, conditions under which the links are traced can be used as preference information.

If, for example, the user selects “Coffee Shop” from the menu on the Web site that provides “Station Area Information”, as shown in FIG. 7, there is a link between the Web site that provides “Station Area Information” and the Web site that provides the menu including “Coffee Shop”. In this case, information required by the user near the station, i.e., terms associated with “Coffee Shop”, e.g., “Food and Drinks”, “Rest Areas”, and “Lunch Break”, are associated and stored as predetermined. With this preference information, when the user accesses the Web site that provides “Station Area Information” again, if he/she has previously selected “Coffee Shop” from the menu, this information can be preferentially displayed on the Web site that provides “Station Area Information”, thus improving the convenience for the user.

A method of acquiring filter conditions for information received through a Web site or electronic mail is available. More specifically, users often receive unwanted unsolicited electronic mail or spam and the like. For example, such mail includes direct mail and advertisement information originated from companies. These pieces of information are useful when required. However, when they are not required, the communication cost for the reception of spam will increase, and spam may occupy the memory, resulting in low availability. In general, to prevent this, a client or server incorporates software for removing electronic mail with specific keywords and those from specific originators. Conditions under which specific electronic mail is removed by such software are called filter conditions. These filter conditions can be used as preference information because they designate specific unnecessary or necessary information. If, for example, a user requires specific news (of specific types and areas), a weather forecast in a limited area, and the like, these pieces of information are profile conditions and profile information.

Profile information can also be acquired from the frequency of access to a specific Web site or conditions for browsing operation. More specifically, preference information can be acquired by using the tendency of a user to access interesting information many times. In this case, the frequency of access to a Web site or a browsing count indicates the degree to which the user is interested in items contained in the Web site, and hence can be effectively used as preference information.

Profile information can also be acquired from the positional information of an access device or the type of line in use. More specifically, if a client that accesses information is a mobile unit, a place in which the user is interested can be specified by the positional information of the mobile unit (a cell number or the like governed by a connecting base station in the case of a portable telephone) while the mobile unit is accessing information. The amounts of information used in a line in use, e.g., a high-speed communication line for an ISDN or the like and a low-speed communication line for portable telephones, can be estimated. Such information can also be used as preference information. Since these information amounts differ in accordance with the contents of information (short mail, images, and moving images greatly differ in information amount), the contents of an information provision service which the user is receiving can be roughly grasped.

In addition, preference information can also be acquired from the use frequency of an access device in use. More specifically, some users switch client devices depending on their purposes and applications. For example, mail mainly consisting of characters may be read through a portable telephone, whereas information having detailed contents and graphic patterns may be read through a PC. Information that the user wants to acquire by switching access devices is important information for the user. Such information can be used as preference information.

Assume that a user who is interested in music acquires new music release information through a portable telephone while downloading desired music data from a Web site through a PC. In this case, access to new music release information through the portable telephone is a factor that causes downloading through the PC. If, therefore, user's preferences are set in new music release information in advance on the basis of preference information and profile information, downloading through the PC is facilitated.

Furthermore, preference information can be acquired from replies to Web contents prepared in a questionnaire form or query formation. More specifically, in an advertisement on a Web site which offers prizes and presents, users are prompted to reply to a series of questions associated with the preferences of the users, e.g., “What kind of food do you like to eat?”, “How much does it cost?”, and “Which area are your favorite restaurants located?”, and user's preferences can be obtained from the replies, thereby acquiring preference information. In this case, many users may want to stay anonymous. Even in this case, if age brackets, sexes, and areas can be specified, such information can be used for merchandize control and planning.

What is claimed is:

1. An information communication system in which a service information provider registers in advance service information in information provision means, managed by a carrier, for providing the service information, and a user receives the service information by accessing the information provision means via a communication network, comprising a database for separately storing profile information indicating attribute information of the user and preference information indicating a preference and taste of the user upon encrypting the profile information and preference information.

2. A system according to claim 1, wherein the profile information and preference information are pieces of information for which the user gave consent to disclosure.

3. A system according to claim 1, further comprising means for generating a keyword for searching/extracting information stored in said database on the service information provider side.

4. A system according to claim 2, further comprising means for generating a keyword for searching/extracting information stored in said database on the service information provider side.

5. A system according to claim 3, further comprising information search means for searching said database to extract information in accordance with the keyword and supplying the extracted information to the service information provider.

6. A system according to claim 4, further comprising information search means for searching said database to extract information in accordance with the keyword and supplying the extracted information to the service information provider.

7. A system according to claim 5, wherein said information search means also supplies key information required to decrypt the extracted information.

8. A system according to claim 6, wherein said information search means also supplies key information required to decrypt the extracted information.

9. A system according to claim 1, further comprising storage means for, when the user accesses said information provision means, obtaining the profile information and preference information in accordance with contents of the access to said information provision means, and storing the profile information and preference information in said database.

10. A system according to claim 9, wherein said storage means acquires and stores terminal attribute information of the user and communication attribute information required to access said information provision means as the profile information.

11. A system according to claim 9, wherein said storage means acquires and stores the preference information on the basis of link information obtained when the user sequentially selects menu items on a display screen in accessing said information provision means.

12. A system according to claim 9, wherein said storage means acquires and stores a filter condition as the preference information which is set when the user receives information from said information provision means and indicates necessity/nonnecessity of information.

13. A system according to claim 9, wherein said storage means acquires and stores positional information and a type of communication line, as the preference information, when the user is accessing.

14. A system according to claim 9, wherein said storage means acquires and stores as the preference information a use frequency of an access device through which the user is accessing.

15. An information communication method in which a service information provider registers in advance service information in information provision means, managed by a carrier, for providing the service information, and a user receives the service information by accessing the information provision means via a communication network, comprising the step of separately storing profile information indicating attribute information of the user and preference information indicating a preference and taste of the user in a database upon encrypting the profile information and preference information.

16. A method according to claim 15, wherein the profile information and preference information are pieces of information for which the user gave consent to disclosure.

17. A method according to claim 15, further comprising the step of generating a keyword for searching/extracting information stored in the database on the service information provider side.

18. A method according to claim 16, further comprising the step of generating a keyword for searching/extracting information stored in the database on the service information provider side.

19. A method according to claim 17, further comprising the information search step of searching the database to extract information in accordance with the keyword and supplying the extracted information to the service information provider.

20. A method according to claim 18, further comprising the information search step of searching the database to extract information in accordance with the keyword and supplying the extracted information to the service information provider.

21. A method according to claim 19, wherein the information search step comprises also supplying key information required to decrypt the extracted information.

22. A method according to claim 20, wherein the information search step comprises also supplying key information required to decrypt the extracted information.

23. A method according to claim 15, further comprising the storage step of, when the user accesses the information provision means, obtaining the profile information and preference information in accordance with contents of the access to the information provision means, and storing the profile information and preference information in the database.

24. A method according to claim 23, wherein the storage step comprises acquiring and storing terminal attribute information of the user and communication attribute information required to access the information provision means as the profile information.

25. A method according to claim 23, wherein the storage step comprises acquiring and storing the preference information on the basis of link information obtained when the user sequentially selects menu items on a display screen in accessing the information provision means.

26. A method according to claim 23, wherein the storage step comprises acquiring and storing a filter condition as the preference information which is set when the user receives information from the information provision means and indicates necessity/nonnecessity of information.

27. A method according to claim 23, wherein the storage step comprises acquiring and storing positional information and a type of communication line, as the preference information, when the user is accessing.

28. A method according to claim 23, wherein the storage step comprises acquiring and storing as the preference information a use frequency of an access device through which the user is accessing.

29. In an information communication system in which a service information provider registers in advance service information in information provision means, managed by a carrier, for providing the service information, and a user receives the service information by accessing the information provision means via a communication network, an information communication business method which uses a database in which profile information indicating attribute information of the user and preference information indicating a preference and taste of the user are stored after the profile information and preference information are encrypted and provides the stored information to the service information provider with a charge, comprising the steps of:
generating a keyword which is used by the service information provider to search the database; and
searching the database in accordance with the keyword, extracting information, and providing the extracted information to the service information provider.

30. A method according to claim 29, wherein the profile information and preference information are pieces of information for which the user gave consent to disclosure.

31. A method according to claim 29, further comprising providing key information for decrypting the extracted information when the extracted information is provided to the service information provider.

32. A method according to claim 30, further comprising providing key information for decrypting the extracted information when the extracted information is provided to the service information provider.
